(19) United States
(12) Patent Application Publication
(10) Pub. No.: US 2003/0205509 A1
(43) Pub. Date: Nov. 6, 2003

(54) Method and system for monitoring water treatment and water quality

(76) Inventors: Joseph R. Barnes, London (CA); William F. Rathborne, London (CA); John R. Thody, Kimbal, MI (US); Philip Whiting, Komoka (CA)

Correspondence Address: Kirk M. Miles, 700 Koppers Building, 436 Seventh Avenue, Piitsburgh, PA, 15219-1818, US

(21) Appl. No.: 10/426,738

(22) Filed: Apr. 30, 2003

Related U.S. Application Data
(60) Provisional application No. 60/376,556, filed on May 1, 2002.

(30) Foreign Application Priority Data
Jan. 24, 2003 (CA) 2,417,360

(51) Int. Cl. B01D 35/00

(52) U.S. Cl. 210/85

(57) ABSTRACT

A system for monitoring fluid treatment and fluid quality comprising a fluid treatment apparatus, at least one treatment-effectiveness sensor adapted, and positioned relative to said treatment apparatus, so as to sense the effectiveness of treatment performed by the treatment apparatus, and so as to emit an alarm signal when the effectiveness of treatment falls outside a predetermined range, and a monitoring system positioned remotely from the treatment apparatus and the treatment effectiveness sensor, the monitoring system being operatively connected to the treatment-effectiveness sensor, the monitoring system being adapted to receive said alarm signal and to indicate an alarm condition in response to said alarm signal.

### FIELD OF THE INVENTION

This invention relates to the field of water treatment and water quality monitoring systems.

### BACKGROUND OF THE INVENTION

Of the many important public health issues, one of the most important is drinking water quality. The presence of pathenogenic organisms and/or contaminants can lead to illness and death in a large number of people in a very short period of time.

As a result, a wide variety of systems have been created to effect the disinfection drinking water, and to remove undesirable contaminants from drinking water. Often, relatively small-scale disinfection systems are used by individual residences and small businesses located in out-of-the-way places. For example, a typical ultra-violet (UV) light disinfection system includes a UV lamp positioned concentrically within a UV-transparent sleeve. The sleeve is surrounded by a UV-opaque cylindrical vessel, shaped so as to permit the water being treated to flow through the vessel, between the sleeve and the vessel. The UV lamp is positioned within the sleeve so that UV light irradiates the water flowing through past the outside of the sleeve and destroys pathenogenic organisms in the water.

In this type of treatment system, to ensure that a sufficient number of pathenogenic organisms are destroyed to create safe drinking water, the water must be subjected to a minimum UV dose, where “dose” is defined as the product of UV intensity and the length of time the water is subjected to the UV light.

Sometimes, such devices would include a UV sensor configured and positioned to measure the size of the UV dose being applied to the water and to activate a warning device such as a light or buzzer if the applied UV dose is inadequate for any reason. This warning device would be activated if the UV sensor indicates that the UV dose is too low, as well as under a variety of other conditions that indicate that the system is failing.

Systems of the type described above have a number of weaknesses. First, the warning device only indicates a general failure of the system. In other words, it only indicates that the water appears not to be receiving an adequate UV dose. However, the general failure could have many causes. For example, the failure could be the result of an interruption of power to the UV lamp. It could also be the result of failure of the UV lamp to light, UV sensor failure, contamination of the sleeve, excessively contaminated water, a water leak, or another cause. The alarms do not differentiate between different causes of failure. Thus, every time an alarm condition exists, the local system operators have to check a variety of different possible causes for the failure. This is particularly problematic because the operators (e.g. homeowners) often have inadequate technical expertise. Therefore, because the alarm does not identify the cause of failure, the operators may perform repairs incorrectly. Hiring professional service personnel is a possibility, but they may be initially unavailable for a period of days or weeks, resulting in extended downtime.

Second, the warning device typically displays or sounds an alarm at the place where the system is located. However, disinfection systems are often installed in remote locations where few if any people are present for extended periods of time. As a result, it is common for long periods of time to pass before the alarm condition is noticed.

Third, as a result of the defects described above, users will often ignore alarms, and, as a result, systems remain inoperative for periods of months or years.

Fourth, many (likely most) home UV systems are installed without including the UV sensor. In this case, the buzzer or warning light can only indicate a failure of the UV lamp to light. In the case where the lamp is operating but the UV dose is below the level needed for disinfection, no alarm would sound and the system user would falsely believe the system was providing adequate water protection.

U.S. Pat. No. 6,023,223 issued Feb. 8, 2000 discloses an early warning detection and notification network for monitoring environmental conditions. The network comprises a plurality of remotely located environmental sensors having a communications uplink to one or more earth-orbiting satellites. The network further comprises a downlink interface to a database server having a communications interface to the Internet. Periodically, the sensors upload environmental condition data to the satellites, which download the data to the server. End-users can then access the database over the Internet.

A problem with the detection system of U.S. Pat. No. 6,023,223 is that it necessitates the use of a complex, expensive communication system which includes one or more earth-orbiting satellites.

U.S. Pat. No. 4,626,992 issued Dec. 2, 1986 to Greaves et al. discloses a water quality monitoring system for detecting sub-lethal degradations in environmental quality. The system monitors movements of living organisms, such as fish, whose movements would tend to vary according to the toxicity of the water. A video camera is used for monitoring.

This system suffers from the problem of being limited to measuring the toxicity of the water indirectly, using relatively large organisms that swim, such as fish. Such a system is expensive, and is too unwieldy for use in residential or small business water purification systems.

### SUMMARY OF THE INVENTION

Therefore, what is required is a system that can effectively disinfect or otherwise treat water or other fluids to desired standards. Preferably, such a system would include a remote monitoring station that can provide for constant monitoring of the disinfection system 24 hours a day, 7 days a week. Also preferably, a fault or failure in the system can be identified with greater precision than is possible with typical prior art device described above. Also preferably, such a system would assist in the diagnosis of faults in the system in the event of a failure.

Therefore, according to one aspect of the invention, there is provided a system for monitoring fluid quality and fluid treatment, the system comprising:

a) a fluid treatment apparatus;

b) at least one treatment-effectiveness sensor adapted, and positioned relative to said treatment apparatus, so as to sense the effectiveness of treatment performed by the treatment apparatus, and so as to emit an alarm signal when the effectiveness of treatment falls outside a predetermined range; and

c) a monitoring system positioned remotely from the treatment apparatus and the treatment effectiveness sensor, the monitoring system being operatively connected to the treatment-effectiveness sensor, the monitoring system being adapted to receive said alarm signal and to indicate an alarm condition in response to said alarm signal.

According to another aspect of the invention, there is provided a method of monitoring fluid quality and treatment, the method comprising the steps of:

1) treating the fluid at a treatment location;

2) sensing if said treating step is effective to a predetermined standard; and

3) if said treating step is not effective to said predetermined standard, emitting an alarm signal for communication to a monitoring location positioned remotely from said treatment location.

### BRIEF DESCRIPTION OF THE DRAWINGS

The invention will now be described, by way of example only, with reference to the drawings described below which show the preferred embodiment of the invention, and in which:

FIG. 1 is a schematic diagram of a generic embodiment of the monitoring system of the present invention;

FIG. 2 is a schematic drawing of the preferred embodiment of the monitoring system;

FIG. 3 is a drawing of a UV disinfection device according to one embodiment of the present invention;

FIG. 4 is a schematic drawing of an alternate embodiment of the present invention; and

FIG. 5 is a table showing the logic used by the alternate embodiment of the present invention.

### DETAILED DESCRIPTION OF THE PREFERRED EMBODIMENTS

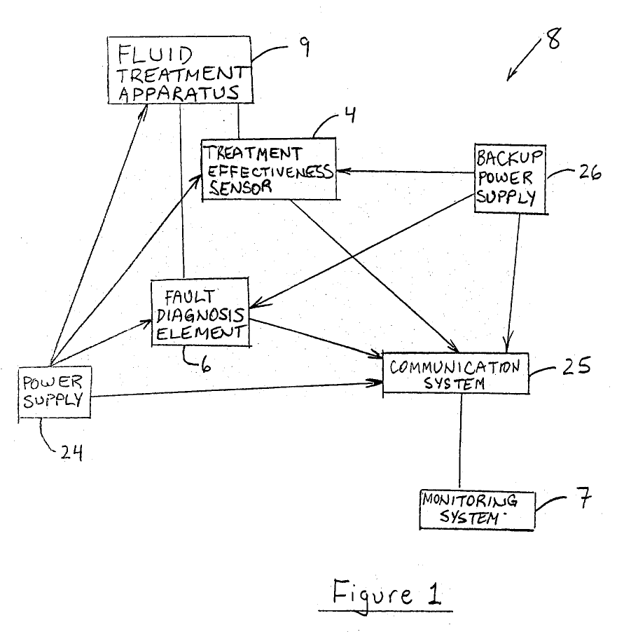

Referring now to FIG. 1, the system 8 comprises a fluid treatment apparatus 9. A treatment-effectiveness sensor 4, and a fault diagnosis element 6 are operatively connected to the apparatus 9 and the communication system 25. The treatment effectiveness sensor 4 is configured to sense if treatment quality is outside of a predetermined range, and to emit an alarm signal if the treatment quality is outside the predetermined range. The fault diagnosis element 6 is configured to diagnose at least one fault and emit a fault signal when the fault is sensed.

The communication system 25 is configured to communicate the alarm signal and fault signal to a monitoring system 7. Preferably, the monitoring system 7 is positioned remotely from the apparatus 9 and the treatment effectiveness sensor 4. The monitoring system 7 is adapted to receive the alarm and fault signals from the communication system 25 and indicate alarm and fault conditions in response.

The system 8 further preferably includes a power supply 24 operatively connected to the apparatus 9, the sensor 4, the fault diagnosis element 6 and the communication system 25. The power supply 24 supplies power to these elements to allow them to perform their functions.

The system 8 also preferably includes a backup power supply 26 operatively connected to the sensor 4, the fault diagnosis element 6 and the communication system 25. In case the power supply 24 fails, the backup power 26 powers the sensor 4, the element 6 and the system 25. Thus, if the power supply 24 fails, the sensor 4 will still be able to emit an alarm signal, the element 6 will still be able to emit a fault signal, and the system 25 will be able to communicate these signals to the monitoring system 7.

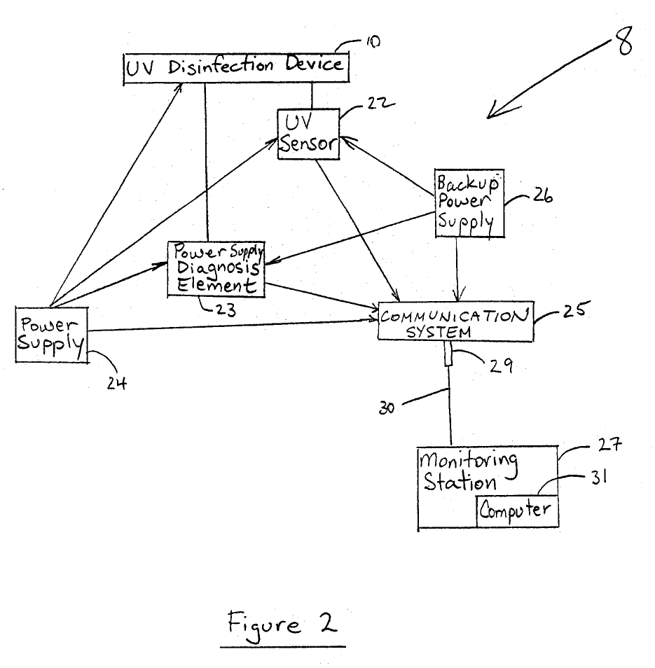

Referring now to FIG. 2, a schematic representation of the preferred system 8 is shown. In this embodiment, the fluid treatment apparatus 9 comprises a UV disinfection device 10.

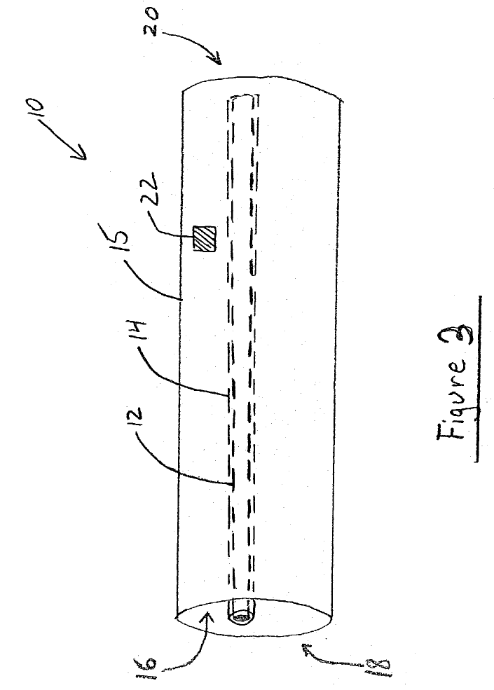

The device 10 is shown in greater detail in FIG. 3. The UV disinfection device 10 comprises a UV lamp 12 and a hollow, annular, UV-transparent sleeve 14. The lamp 12 is mounted generally concentrically within the sleeve 14. The sleeve 14 is concentrically surrounded by a UV-opaque reactor housing 15, thus defining a treatment location in the form of an annular flow space 16 between the sleeve 14 and the reactor housing 15.

In operation, water or another fluid to be disinfected flows into the flow space 16 at the inlet 18 of the housing 15. As it flows through the flow space 16, the water is subjected to UV radiation being emitted by the lamp 12. The water then exits the housing 15 via the outlet 20.

The power supplied to device 10 is typically passed through a ballast (not shown) which changes the frequency and/or voltage of the incoming power to make it usable by the lamp 12.

It will be appreciated by those skilled in the art that the purpose of irradiating the water with UV radiation is to disinfect the water by inactivating a sufficiently high percentage of microorganisms within the water so that it is safely potable. Thus, in this embodiment, the dose of UV radiation imparted to the water must be sufficient to adequately disinfect the water.

It will also be appreciated that the above-described UV disinfection device is preferable because it is an easily available, off-the-shelf device that is reasonably priced, and is therefore appropriate for use by individual residential customers and small businesses. However, it will also be appreciated that the invention comprehends other kinds of fluid treatment apparatus. This includes other disinfection devices, as well as other types of fluid treatment apparatus. Examples include reverse osmosis, ultrafiltration, nanofiltration, activated carbon adsorption, particulate filtration, water softeners and ion exchange. What is important is that the system 8 include a fluid treatment apparatus 9.

Referring again to FIG. 2, the treatment effectiveness sensor 4 is a UV sensor 22. The system 8 further includes a treatment-effectiveness sensor adapted, and positioned relative to the UV disinfection device 10, so as to sense the effectiveness of the device 10 and so as to emit an alarm signal when the effectiveness of the treatment falls outside a predetermined range, or, more generally when the treatment is not effective to a predetermined standard. Most preferably, the UV sensor 22 is operatively connected to the disinfection device 10, and is positioned on or inside the housing 15 and configured to sense the effectiveness of treatment by providing a continuous measurement of UV irradiance that is being transmitted through the fluid flowing through the flow space 16. Thus, the sensor 22 provides a measure of the effectiveness of the device 10 in disinfecting the water or other fluid by sensing the size of the UV dose being imparted by the lamp 12 to the fluid. In addition, the UV sensor 22 is configured to emit an alarm signal when the UV dose being imparted to the fluid falls outside of the predetermined range of UV dosages that would result in sufficient disinfection of the fluid.

It will be appreciated by those skilled in the art that, although the preferred form of the treatment effectiveness sensor is the UV sensor 22, the invention comprehends other kinds of treatment effectiveness sensor. The type of treatment effectiveness sensor used depends on a number of factors, including the type of fluid treatment process being employed. What is important is that the system include a treatment effectiveness sensor adapted to sense the effectiveness of treatment.

Preferably, the fault diagnosis element of the system 8 takes the form of a power supply diagnosis element 23 operatively connected to the disinfection device 10. The power supply diagnosis element 23 is configured to sense and diagnose a power supply fault, i.e. to sense whether or not adequate power is being supplied to the system 8. If it is not, the power supply diagnosis element 23 emits a fault signal in the form of a power supply delivery fault signal, thus identifying the sensed power supply fault.

It will be appreciated that it is possible for the system 8 to include more than one fault diagnosis element. Other possible diagnosis elements include a lamp failure diagnosis element (configured to sense/diagnose lamp failure faults), a UV sensor diagnosis element (configured to sense/diagnose sensor failure faults), a power delivery diagnosis element (configured to sense/diagnose power delivery failure faults i.e. if power is being delivered from the ballast to the lamp), a contamination diagnosis element for sensing excessive contamination of water and/or of the sleeve 14 (configured to sense/diagnose fouled sleeve/water faults), a low-emission fault diagnosis element (configured to sense/diagnose a lamp low emission fault i.e. that the lamp is on but emitted UV radiation at too low a level) and a water leak diagnosis element (configured to sense/diagnose water leak faults i.e. if water is leaking from the system). Each of these fault diagnosis elements can be operatively connected to the apparatus 9. Each can also be configured to emit a corresponding fault signal when the fault is sensed. Other fault diagnosis elements are also possible.

The system 8 may include one or more fault diagnosis elements 6, operatively connected to the apparatus 9 and each configured to sense and diagnose at least one possible fault and emit a fault signal when the fault is sensed. Most preferably, however, the system 8 will comprise a single fault diagnosis element, namely, the power supply diagnosis element 23. It will be appreciated that the purpose of the fault diagnosis elements is to assist service personnel in identifying a fault in the system 8 when the treatment effectiveness sensor 4 indicates that effective treatment is not taking place. Thus, the more fault diagnosis elements 6 are included in the system 8, the more precisely and comprehensively faults can be identified. On the other hand, the greater the number of fault diagnosis elements, the more complex the system 8 becomes, and the more expensive the system 8 becomes to manufacture and maintain. It has been found that, in a large majority of cases, the fault in the system 8 will be a power supply fault. Thus, it is believed that in many systems, the additional cost associated with additional fault diagnosis elements is not justified by the relatively small advantage of having the additional fault diagnosis elements.

However, there may be some cases in which it would be advantageous to have at least two fault diagnosis elements selected from the fault diagnosis elements described above, and configured to diagnose at least two possible faults. In some cases, it may be advantageous to have still more fault diagnosis elements, selected from the group described above, or including other fault diagnosis elements not specified herein.

It will be appreciated that, as technology advances, it may be possible to include a larger number of fault diagnosis elements 6 in the system 8 at a low cost. When that happens, it may be preferably to include more fault diagnosis elements 6 in the system 8.

It will also be appreciated that, if desired, the fault diagnosis elements 6, the treatment effectiveness sensor 4 and the communication system 25 can be physically part of one device, if desired. Alternatively, they can be separate elements as shown schematically in FIG. 2. What is important is that each of the system 25, sensor 4 and elements 6 perform their respective functions.

The system 8 also preferably includes a power supply 24, which is operatively connected to the lamp 12, to the sensor 22 and the power supply diagnosis element 23. The power supply 24 supplies power to all of these components.

The system 8 further preferably includes a backup power supply 26. The backup power supply 26 is operatively connected to the sensor 22, the power diagnosis element 23 and the communication system 25. These components are powered by the backup power supply 26 in the case of a failure of the power supply 24. If such a failure occurs, the sensor 22 will have power and be able to emit an alarm signal. Similarly, the power diagnosis element 23 will be able to emit a fault signal, and the system 25 will be able to communicate the signals to the monitoring station 27.

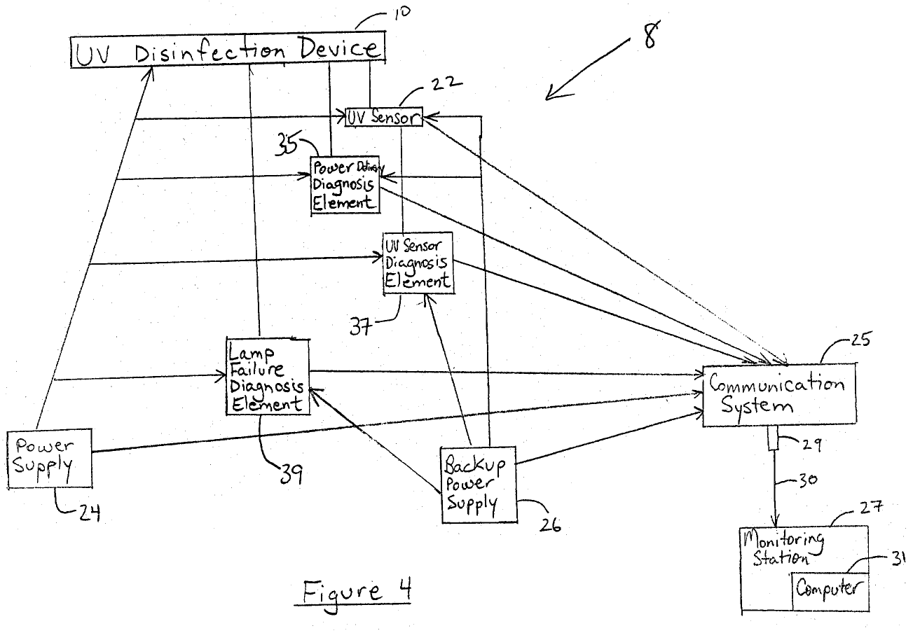

The system 8 preferably further includes a communication system 25 operatively connected to the sensor 22 and the power diagnosis element 23. In embodiments that includes additional fault diagnosis elements (see FIG. 4), the communication system 25 is also operatively connected to those fault diagnosis elements. The communication system 25 is configured to receive the alarm signal emitted by the sensor 22 and communicate the alarm signal to a remote monitoring station 27 included in a monitoring system 7. The communication system 25 is also configured to receive one or more fault signals from one or more fault diagnosis elements 6 and to communicate the fault signals to the monitoring station 27.

Most preferably, the communication system 25 will include a telephone connection 29 and/or a telephone line 30 for communicating the alarm signal and fault signal to the monitoring station 27. It will be appreciated that a telephone connection 29 is preferred because telephone lines 30 are typically quite reliable, and also commonly available. However, it will also be appreciated that in some locations, telephone connections are not easily available. In that case, it may be necessary instead for the system 25 to include a communication connection to a wireless communication transmitter. Examples of possible wireless communication systems 25 include radio, infrared, microwave or other wireless systems.

It will be appreciated that, though certain types of communication systems 25 may be preferred, the invention comprehends other types of communication systems 25. For example, a communication system 25 comprising a coaxial cable connection (i.e. the medium used to carry cable TV) could be used, as could an internet connection. What is important is that the system 8 preferably include a communication system 25 to communicate alarm and fault signals to the monitoring system.

The system 8 preferably further includes a monitoring system 7, preferably adapted to receive alarm and fault signals, indicate at the monitoring location an alarm condition in response to the alarm signal, and indicate at the monitoring location a fault condition in response to a fault signal. The monitoring system 7 is operatively connected to the sensor 22. Preferably, this connection is made via an operative connection to the communication system 25, which is in turn operatively connected to the sensor 22. This operative connection may comprise a wireless, telephone or other link, depending on the type of communication system 25 in use.

It will be appreciated that treatment devices such as the UV disinfection device 10 described above are often found in out-of-the-way locations where it is impractical to monitor the system locally. Therefore, preferably, the monitoring system 7, and in particular the monitoring station 27, are positioned at a monitoring location remote from the treatment location, i.e. the location where the treatment apparatus 9 treats the fluid, and from the sensor 22. In this way, it is possible for the system to be monitored even when nobody is present at the treatment location.

Preferably, the monitoring station 27 will include a PC or other computer 31 which will monitor the system 8 for alarm and fault signals. The computer 31 is preferably programmed to receive an alarm signal and indicate an alarm condition in response to the alarm signal. The computer 31 will also preferably be programmed to receive a fault signal and indicate a fault condition in response to the fault signal.

It will be appreciated that the remote monitoring capability makes the monitoring of large numbers of out-of-the-way systems 8 convenient and inexpensive. This is because large numbers of such systems 8 can be monitored from a single monitoring station 27. House or business alarm service providers also monitor large numbers of alarm systems at a single monitoring station. For example, a typical home alarm service provider has a monitoring station monitoring many home alarms. When one of the alarms is tripped, the monitoring station takes appropriate action such as contacting the police. Thus, a house-or-business alarm service provider is well-suited to provide a similar service for monitoring water quality and treatment. If an alarm or fault signal is received, appropriate action, such as contacting service personnel, could be taken. Thus, a monitoring station 27 associated with a house-or business alarm service provider may be conveniently usable for monitoring the treatment apparatus 9.

FIG. 4 shows an alternate to the preferred embodiment of the invention. In this alternate embodiment, there are three fault diagnosis elements, rather than the single fault diagnosis element of the preferred embodiment. The three fault diagnosis elements are a power delivery diagnosis element 35, a UV sensor diagnosis element 37 and a lamp failure diagnosis element 39. Each of the three diagnosis elements 35, 37, 39 are operatively connected to the communication system 25 and emit a fault signal when a corresponding fault is sensed.

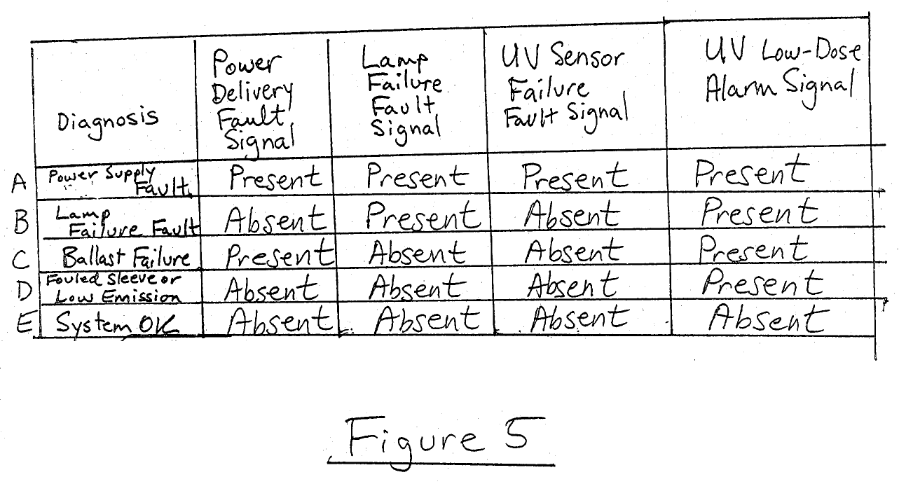

FIG. 5 is a table that shows the correspondence between particular diagnoses and the fault signals that are being emitted. Along the top of the table, the three possible fault signals (power delivery fault signal, UV sensor fault signal, lamp failure fault signal), as well as the alarm signal, are listed. There are five possible cases, labelled as A-E on the left side of the table.

In case A, all of the signals are present. This indicates the presence of a power supply fault. It will be appreciated that if power is not being delivered to the device 10, then the lamp 12 will not receive power from the ballast and will not function. Therefore, it is likely that the lamp failure fault signal is the result of the power supply fault, and that once the power supply fault is fixed, the lamp failure fault signal will disappear. However, it is also possible that, by coincidence, the lamp 12 has failed at the same time as the power delivery fault. Therefore, the diagnosis in case A is a power supply fault. If the lamp failure fault signal is still present once the power supply fault has been repaired, the appropriate diagnosis can be made and the lamp failure fault fixed.

In case B, only the lamp failure fault signal and the alarm signal are present. Thus, the diagnosis is a lamp failure fault.

In case C, only the power delivery fault signal and alarm signal are present. Since power is being supplied to the system generally (as indicated by the absence of the other signals), the diagnosis is a ballast failure fault.

In case D, only the alarm signal is present. Therefore, the diagnosis is that the fault is one for which no specific diagnosis element is provided in this embodiment e.g. a fouled sleeve fault or lamp low emission fault.

In case E, no signals are present, indicating that the system is functioning properly.

It will be appreciated that, in the alternate embodiment of FIG. 4 where more than one fault diagnosis element is used, the diagnosis and identification of faults is accomplished with reference to all of the fault signals present or absent. By application of binary logic (for example, as shown in FIG. 5), the fault signals are used to identify and diagnose one or more faults.

There are a number of ways that the identification and diagnosis can take place in the alternate embodiment. For example, a set of binary switches, associated with the communication system 25, can receive the one or more fault signals. The binary switches would be arranged so as to identify which case (A, B, C, D or E) is present. The communication system 25 would then communicate a modified fault signal (i.e. the output of the set of binary switches) to the monitoring station 27. This modified fault signal transmitted by the communication system 25 would identify and diagnose the fault or faults that are present, and appropriate steps could be taken to remedy the faults.

Another possibility is that the fault signals emitted by the fault diagnosis elements are simply communicated by the communication system 25 to the monitoring station 27. The computer 31 is programmed to use the information contained in the one or more fault signals to identify and diagnose the fault or faults, for example, using the logic shown in FIG. 5.

It will be appreciated that, in either case, the fault signal or signals transmitted to the monitoring station 27 identify or diagnose the fault or faults that were sensed by the fault diagnosis elements.

It will be appreciated that, in the preferred embodiment described above, the fault diagnosis elements 6 and the treatment-effectiveness sensor 4 operate in a binary fashion, in that they simply sense and indicate alarm and/or fault situations. However, it will also be appreciated that more complex data could be communicated by the fault diagnosis elements or treatment-effectiveness sensor. This would typically be done using a status signal, which contains information not merely about whether there is a fault or a treatment failure, but about the actual status of the treatment effectiveness or the functioning of elements of the system 8, regardless of whether a fault or alarm is present. Thus, the treatment effectiveness sensor can emit a treatment status signal that will indicate the precise level of treatment effectiveness, e.g. the precise size of the dose of UV being imparted to the fluid. In this context, “precise” means with greater precision than simply indicating, via an alarm signal, whether the treatment is adequately or inadequately effective. The treatment status signal may contain a measurement of a parameter of treatment effectiveness, such as UV dosage level.

It will be appreciated that if the treatment status signal indicates that treatment has fallen outside a predetermined range of effectiveness, then it would be functioning as an “alarm” signal.

Similarly, the fault diagnosis elements can emit function status signals that indicate the precise status of system functions regardless of whether a fault is present. In this context, “precise” means with greater precision than simply indicating whether a fault exists in one of the system functions by means of a fault signal. For example, the power diagnosis element 23 could emit a function status signal giving the level of power (in watts) being delivered to the lamp. Alternatively, the voltage and/or current could be indicated. The function status signal may contain a measurement of a parameter that indicates the level of the system function.

It will be appreciated that, if a function status signal is indicating a function level that constitutes a fault, then it functions as a “fault” signal.

If treatment effectiveness and function status signals are used, then the station 27 will preferably be adapted to receive these signals and indicate treatment effectiveness status and/or function status. It will be appreciated that the computer 31 can be well-suited to receive and process these signals and indicate status.

It will also be appreciated that the status signals could be emitted continuously or intermittently, as desired.

While the foregoing embodiments of the present invention have been set forth in considerable detail for purpose of making a complete disclosure of the invention, it will be apparent to those skilled the art that various modifications can be made to the system without departing from the broad scope of the invention as defined in the attached claims. Some of these variations are discussed above and others will be apparent to those skilled in the art. For example, the system 8 may include one or more fault diagnosis elements. Each of these fault diagnosis elements may be positioned either locally in relation to the treatment location, or remotely. For example, they may be positioned in or near the monitoring station 27. What is important is that the system 8 preferably capable of remote monitoring of fluid quality and treatment.

The embodiments of the invention in which an exclusive property or privilege is claimed are defined as follows:

1. A system for monitoring fluid treatment and fluid quality, the system comprising:
a) a fluid treatment apparatus;
b) at least one treatment-effectiveness sensor adapted, and positioned relative to said treatment apparatus, so as to sense the effectiveness of treatment performed by the treatment apparatus, and so as to emit an alarm signal when the effectiveness of treatment falls outside a predetermined range; and
c) a monitoring system positioned remotely from the treatment apparatus and the treatment effectiveness sensor, the monitoring system being operatively connected to the treatment-effectiveness sensor, the monitoring system being adapted to receive said alarm signal and to indicate an alarm condition in response to said alarm signal.

2. The system of claim 1, further comprising at least one fault diagnosis element, the at least one fault diagnosis element being operatively connected to the treatment apparatus and being configured to diagnose at least one possible fault within said treatment apparatus and to emit a fault signal when said at least one fault is diagnosed.

3. The system of claim 2, wherein the treatment apparatus comprises (1) a disinfection device and (2) a power supply for supplying power to said disinfection device, and wherein the fault diagnosis element comprises a power diagnosis element, the power diagnosis element being operatively connected to the treatment apparatus, and being configured to sense whether adequate power is being delivered to the disinfection device, said fault signal comprising a power delivery fault signal.

4. The system of claim 1, wherein the treatment apparatus comprises an ultraviolet light disinfection device configured to impart a dose of ultraviolet light to said fluid.

5. The system of claim 2, wherein the treatment apparatus comprises an ultraviolet light disinfection device configured to impart a dose of ultraviolet light to said fluid.

6. The system of claim 4, wherein the treatment-effectiveness sensor comprises a UV sensor configured, and positioned relative to said ultraviolet light disinfection device, so as to sense if said dose falls outside a predetermined disinfection range, and so as to emit said alarm signal when said dose falls outside said predetermined disinfection range.

7. The system of claim 5, wherein the treatment-effectiveness sensor comprises a UV sensor configured, and positioned relative to said ultraviolet light disinfection device, so as to sense if said dose falls outside a predetermined disinfection range, and so as to emit said alarm signal when said dose falls outside said predetermined disinfection range.

8. The system of claim 1, the system further comprising a communication system operatively connected to the treatment-effectiveness sensor, the monitoring system comprising a monitoring station remote from said treatment apparatus and operatively connected to the communication system, the communication system being configured to communicate said alarm signal to said remote monitoring station, the monitoring station being configured to receive said alarm signal and indicate an alarm condition in response to said alarm signal.

9. The system of claim 2, the system further comprising a communication system operatively connected to the treatment effectiveness sensor and to the at least one fault diagnosis element, the monitoring system comprising a monitoring station remote from said treatment apparatus and operatively connected to the communication system, the communication apparatus being configured to communicate said alarm signal and said fault signal to said monitoring station, the monitoring station being configured to receive said alarm signal and fault signal and indicate an alarm condition in response to said alarm signal and a fault condition in response to said fault signal.

10. The system of claim 8 or claim 9, wherein said communication apparatus comprises a telephone connection.

11. The system of claim 8 or claim 9, wherein said communication apparatus comprises a wireless communication connection.

12. The system of claim 8 or claim 9, wherein said monitoring station comprises a computer, the computer being programmed to receive said alarm signal and indicate said alarm condition in response to said alarm signal.

13. The system of claim 2, wherein the system comprises at least two fault diagnosis elements configured to diagnose at least two possible faults, the at least two fault diagnosis elements being selected from a group of fault diagnosis elements that includes a power diagnosis element, a water leak diagnosis element, a power supply diagnosis element, a contamination diagnosis element, and a sensor failure diagnosis element, each of said at least two fault diagnosis elements being configured to emit a fault signal identifying a diagnosed fault.

14. The system of claim 8 or claim 9, wherein said monitoring station is associated with a house-or-business alarm service provider.

15. The system of claim 1, wherein said treatment effectiveness sensor is further adapted to emit a treatment status signal indicating a precise level of treatment effectiveness, the monitoring system being adapted to receive said treatment status signal and to indicate a treatment status.

16. The system of claim 6, wherein said UV sensor is further adapted to emit a treatment effectiveness signal indicating a precise level of UV dosage being imparted to said fluid.

17. A method monitoring fluid quality and treatment, the method comprising the steps of:
1) treating the fluid at a treatment location;
2) sensing if said treating step is effective to a predetermined standard; and
3) if said treating step is not effective to said predetermined standard, emitting an alarm signal for communication to a monitoring location positioned remotely from said treatment location.

18. The method of claim 17, wherein said method further comprises the step of monitoring for said alarm signal from said monitoring location remote from said disinfection location.

19. The method of claim 17 or claim 18, further comprising the step of communicating said alarm signal to said monitoring location remote from said treatment location.

20. The method of claim 19, further comprising the step of indicating an alarm condition at said monitoring location remote from said treatment location.

21. The method of claim 17 or claim 18, wherein said treating step comprises imparting a UV dose to said fluid.

22. The method of claim 21, wherein said sensing step comprises sensing if said UV dose is outside a predetermined range.

23. The method of claim 17, further comprising the steps of (1) sensing the presence of a fault in a treatment apparatus and (2) if a fault is sensed, emitting a fault signal.

24. The method of claim 23, further comprising the step of monitoring for said alarm signal and for said fault signal from said monitoring location remote from said disinfection location.

25. The method of claim 23 or 24, further comprising the step of communicating said alarm signal and said fault signal to said monitoring location remote from said treatment location.

26. The method of claim 25, further comprising the step of indicating an alarm condition and a fault condition at said monitoring location.

27. The method of clam 23 or claim 24, wherein said treating step comprises imparting a UV dose to said fluid.

28. The method of claim 27, wherein said step of sensing the presence of a fault comprises the step of sensing if adequate power is being delivered to said treatment apparatus.

29. The method of claim 23 or 24, wherein the step of sensing the presence of a fault comprises the step of sensing the presence of a fault selected from the group of faults consisting of a power delivery fault, a power supply fault, a water leak fault and a sensor failure fault.

30. The method of claim 29, wherein said step of emitting a fault signal comprises the step of emitting a fault signal that identifies a sensed fault.

31. The method claim 16, the method further comprising the step of communicating a precise level of treatment effectiveness to said monitoring station.
